(19) United States
(12) Patent Application Publication
(10) Pub. No.: US 2021/0245545 A1
(43) Pub. Date: Aug. 12, 2021

(54) COLOR-TRANSFER WICKING ART KIT

(71) Applicant: Crayola LLC, Easton, PA (US)

(72) Inventors: Robert J. Henry, Bethlehem, PA (US); Regan Johnson, Fleetwood, PA (US); Jennifer Kesilman, Bethlehem, PA (US); Scott Zelachowski, Wind Gap, PA (US)

(73) Assignee: Crayola LLC, Easton, PA (US)

(21) Appl. No.: 17/171,792

(22) Filed: Feb. 9, 2021

Related U.S. Application Data
(60) Provisional application No. 62/972,423, filed on Feb. 10, 2020.

(51) Int. Cl. B44D 2/00; D21H 21/28

(52) U.S. Cl. CPC B44D 2/002; D21H 21/28

(57) ABSTRACT

Devices and kits for making crafts are disclosed herein. The crafts disclosed herein are able to be personalized by coloring them with desired colors using a color-transfer wicking art kits. Further, the kits and devices disclosed herein demonstrate physical phenomena, such as capillary action, to spark artistic play and scientific curiosity.

### FIELD

The present disclosure relates to a tool for play inspiring artistic creativity and scientific curiosity.

### SUMMARY

This summary is intended to introduce a selection of concepts in a simplified form that are further described below in the detailed description section of this disclosure. This summary is not intended to identify key or essential features of the claimed subject matter, nor is it intended to be used as an aid in determining the scope of the claimed subject matter.

In brief, this disclosure describes, among other things, a color-transfer wicking art kit. Although shown and described in the context of a flower building color-transfer wicking art kit that includes a wicking substrate shaped like flower petals, any shape of wicking substrate is contemplated within the scope of the present disclosure in order to make different colored objects. For example, wicking substrates may be shaped to produce butterflies, dragonflies, stars, hearts, or any other shape or form suitable for the color-transfer craft kit disclosed herein.

Continuing with the flower example, the flower, in accordance with aspects herein, once assembled, can be “watered,” i.e., provided with a color-transfer liquid. The color-transfer liquid may include any liquid having a color component such as ink of a desired color, a mixture of ink colors to achieve a personalized desired ink color, and/or an ink/water mixture or solution, depending on the consistency of the ink. As the flower is “watered” and as the flower petals absorb the “water,” i.e., the color-transfer liquid, by capillary action, the flower petals become colored, and the flower may also bloom, the more saturated with “water” it becomes.

In one embodiment, a color-transfer wicking art kit for making a colored object from a wicking substrate is provided. In this embodiment, the kit includes a nib made at least in part from a porous medium through which a liquid may move via capillary action. The nib may include a first portion or head in fluid flow communication with a second portion or tail. The head and tail may be formed integrally together and may be in direct or indirect contact. The tail may extend outwardly from the head. The nib used in the kit may be a nib that is typically constructed or formed for use in markers. At least a portion of the head may be larger in diameter than the tail. The nib may include an outer shell or casing that covers a portion of the porous media, such as a molded plastic shell.

The kit of this embodiment additionally includes an elongated reservoir made at least in part from a porous medium through which a liquid may move. The reservoir has a first end in fluid flow communication with a second end and is constructed to serve as a conduit for fluid to flow from the first or lower end to the second or upper end and vice versa via capillary action. The reservoir may be a reservoir that is typically constructed or formed for use in markers. The reservoir may have a hollow core. The reservoir may include an outer shell or casing that covers a portion of the porous media, such as a molded plastic barrel.

A support coupling is configured to releasably connect the second end of the reservoir in fluid flow communication with the tail of the nib and includes a substrate support surface. The support coupling may include a channel extending through the coupling from the substrate support surface to a second or lower surface. The channel may be configured to receive an end of the tail of the nib adjacent the substrate support surface, and may be configured to receive the second end of the reservoir adjacent the second surface. The nib and support coupling are configured such that when the tail of the nib is inserted through a wicking substrate and connected in fluid flow communication with the second end of the reservoir via the support coupling, the substrate is releasably affixed in a wicking position between the head of the nib and the substrate support surface in fluid flow communication with the nib. In this embodiment, the nib and support coupling are configured such that the tail of the nib may be inserted through a plurality of wicking substrates in a stacked configuration and connected in fluid flow communication with the second end of the reservoir via the support coupling, the plurality of wicking substrates being releasably affixed in the stacked configuration between the head of the nib and the substrate support surface in fluid flow communication with the nib.

The kit may additionally include at least one wicking substrate through which a liquid may move via capillary action. The wicking substrate may be made from a round filter paper disk that has been cut into a shape. The wicking substrate may be in the shape of a plurality of flower petals extending outwardly from a central hub. The wicking substrate may alternatively be a round filter paper disk with decorative indicia. The indicia may include an outline of a shape that the user can cut along to create a wicking substrate of that shape. The kit may include a plurality of wicking substrates, wherein at least one substrate is a different shape or size than another substrate. The kit may also include a plurality of wicking substrates including petal-shaped portions, such that when two or more substrates are affixed in a stacked configuration, they appear like flowers.

The substrate support surface of the support coupler may be a well-shaped surface having a bottom wall and a peripheral sidewall extending upwardly from the bottom wall. The wicking substrate may have a central hub portion that corresponds with the shape and size of the well-shaped surface such that at least a portion of the central hub is in abutting engagement with the bottom wall when releasably affixed in the stacked position. In this embodiment where one or more wicking substrates have portions shaped like flower petals, the substrate support surface may be shaped like a flower sepal.

The kit may additionally include a wicking vessel configured to hold a liquid such that the first end of the reservoir is in fluid flow communication with the liquid when the reservoir is inserted into the wicking vessel. The wicking vessel may be shaped to correspond with the colored object being made using the kit. For example, where the colored object is a flower, the wicking vessel may be shaped like a flower pot. A cover plate configured to cover an open top in the wicking vessel may also be included in the kit. The cover plate may include a reservoir support opening configured to removeably receive the first end of the reservoir and support the reservoir in an upright position with the first end of the reservoir positioned within the vessel and the second end positioned above the vessel. The cover plate may also include a pour opening configured to allow liquid to be added to the interior of the vessel from outside the vessel through the pour opening.

The kit may additionally include at least one ink bottle, a transfer vessel configured to retain liquid and to transfer liquid to the interior of the wicking vessel (such as a watering can), a color mixing chart, and/or at least one writing instrument (such as a marker). The kit may also include at least one decorative ring having a ring portion configured to be worn on a user's finger and a connector extending upwardly from the ring portion configured to releasably affix the support coupling to the top of the ring. In this manner the colored object when affixed to the support coupling via the nib can be displayed on the ring.

In another embodiment, a flower building art kit includes a first color-transfer paper disk having a first size and having a petal shaped design or shape; a second color-transfer paper disk having a second size different from the first size and having a petal shaped design or shape; an elongated color-transfer liquid reservoir adapted to convey liquid from a bottom end to a top end via capillary action; one or more connectors configured to retain the first color-transfer paper disk and the second color-transfer paper disk in a stacked configuration above the top end of the reservoir and in fluid flow communication with the reservoir; a container configured to retain a color-transfer liquid; and a cover plate configured to cover an open top of the container and having one or more openings through which the bottom end of the reservoir may extend into an interior of the container to contact color-transfer liquid contained within the container.

The one or more connectors may include a nib configured to extend through the first color-transfer paper disk and the second color-transfer paper disk to retain the disks in a stacked configuration. The nib and/or reservoir may be the nib and reservoir components used in markers respectively. The first color-transfer paper disk and the second color-transfer paper disk may be made of an absorbent material.

Each of the first color-transfer paper disk and the second color-transfer paper disk may include a central hole. In this embodiment, the nib may include a first or front portion and second or back portion, wherein the second portion is narrower than the first portion. The second portion of the nib may be configured to fit through the central hole of each of the first color-transfer paper disk and the second color-transfer paper disk. In this embodiment, the one or more connectors may additionally include a nib connector configured to hold the first color-transfer paper disk and the second color-transfer paper disk in the stacked configuration on a first surface of the nib connector when the second portion of the nib is fitted through the central hole of the first color-transfer paper disk and the second color-transfer paper disk, and fitted through an opening in the first surface of the nib connector. The opening of the nib connector may be further configured to receive the reservoir through a second surface of the nib connector such that the reservoir engages with the second portion of the nib.

The cover plate of the flower building kit may include a side notch on a perimeter of the cover plate that provides access to an interior of the container. The kit may additionally include one or more ink bottles. The side notch of the cover plate and the ink bottles may be configured to enable a user to feed ink from the one or more ink bottles through the side notch of the cover plate.

In this exemplary flower building kit, a petal support surface may additionally be included to support the first color-transfer paper disk and the second color-transfer paper disk in the stacked configuration above the top end of the reservoir such that the outer perimeter of each disk is positioned higher than an inner portion of each disk. This petal support surface may be formed integrally with one or more of the connectors, such as a portion of the nib connector.

Another embodiment of a color-transfer wicking art kit includes: one or more die-cut paper substrates having an inner portion and an outer perimeter; at least one wicking reservoir having a first end and a second end, wherein the at least one wicking connector is configured to transfer a color-transfer liquid from the first end in a position remote from the one or more die-cut paper substrates to the second end in a position adjacent the one or more die-cut paper substrates; and an adapter coupling configured to couple the one or more die-cut paper substrates and the at least one wicking reservoir, such that the one or more die-cut paper substrates are positioned at a first height above the color-transfer liquid, and wherein the color-transfer liquid is positioned within a holding component at a second height below the die-cut paper substrate. The die-cut paper substrates may include a plurality of substrates of one or more different shapes and/or sizes. The die-cut paper substrates may include petal shaped portions such that when the die-cut paper substrates are positioned in a stacked orientation, they resemble a flower.

Additional objects, advantages, and novel features are further described in the detailed description, and in part, will become apparent to those skilled in the art upon examination of this disclosure, or may be learned through practice of the various embodiments of this disclosure.

### BRIEF DESCRIPTION OF THE DRAWINGS

The present technology is described in detail below with reference to the attached drawing figures, wherein:

FIG. 1 depicts an exemplary flower building color-transfer wicking art kit in accordance with aspects herein;

FIG. 2A depicts an alignment of a nib, a nib connector, and an ink reservoir of the flower building color-transfer wicking art kit of FIG. 1 when assembling a flower, in accordance with aspects herein;

FIG. 2B depicts a cross-sectional view of an assembled flower in accordance with FIG. 2A;

FIG. 3 depicts a plurality of exemplary color-transfer paper disks, in accordance with aspects herein;

FIGS. 4A-4C depict different stages of a flower adopting color through capillary action, in accordance with aspects herein;

FIGS. 5A-5C depict different stages of a blooming flower, in accordance with aspects herein;

FIG. 6 depicts an exemplary butterfly building color-transfer wicking art kit in accordance with aspects herein; and

FIG. 7 depicts an exemplary butterfly color-transfer wicking art kit in accordance with aspects herein.

### DETAILED DESCRIPTION

The subject matter of the present disclosure is described with specificity herein to meet statutory requirements. However, the description is not intended to limit the scope of the technology. Rather, the claimed subject matter may be embodied in other ways, such as to include different steps, combinations of steps, features, or combinations of features, similar to the ones described in this disclosure, and in conjunction with other present or future technologies. Moreover, although the term “step” may be used to identify different elements of methods employed, the term should not be interpreted as implying any particular order among or between various steps unless and except when the order of individual steps is explicitly described and required.

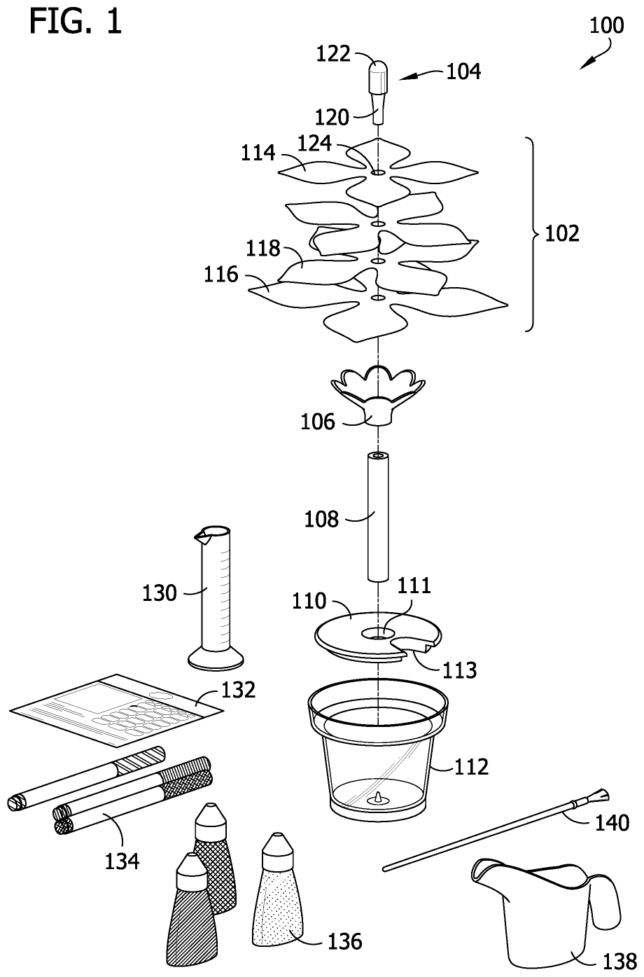

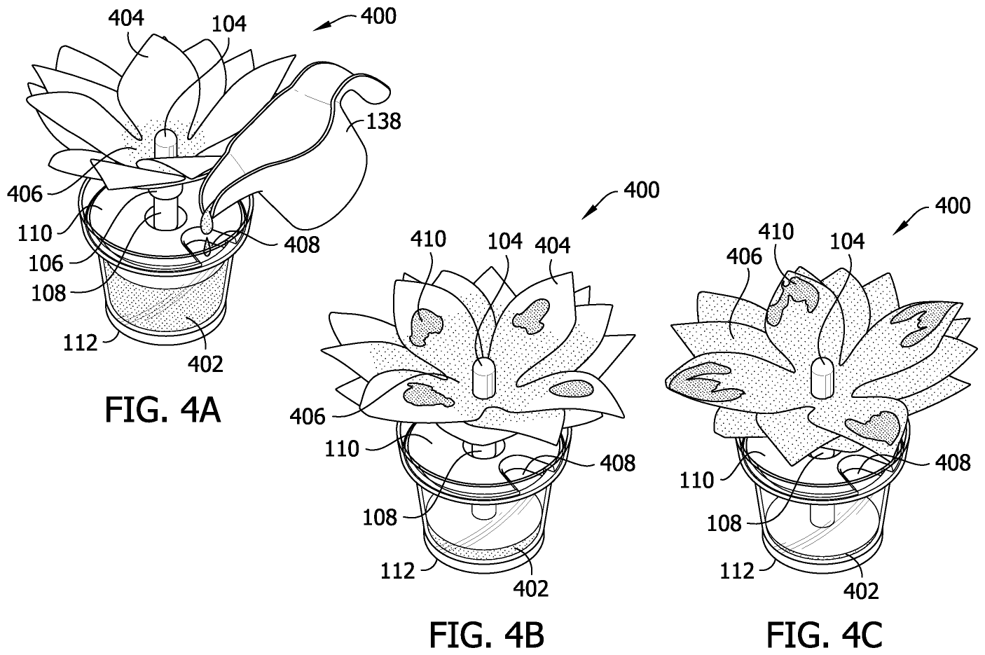

At a high level, embodiments of the present technology relate to a tool for play that inspires creativity as well as scientific curiosity. The tool for play in accordance with aspects herein utilizes the scientific principles of capillary action. For instance, an exemplary color-transfer wicking art kit 100 for building a flower is shown in FIG. 1. The flower building kit, at a minimum, includes a plurality of color-transfer paper disks 102 shaped to form flower petals, a nib 104, a support funnel 106, an ink reservoir 108, a cover plate 110, and a pot 112. The flower building kit components including the plurality of color-transfer paper disks 102, a nib 104, a support funnel 106, an ink reservoir 108, a cover plate 110, and a pot 112, when assembled, as will become more apparent with respect to FIGS. 4A-4C, create a paper flower(s) that can be personalized by adding different colors with the act of “watering” the flower(s). The principle of capillary action (i.e., wicking) can be observed by the user in real time as colored “water” is absorbed by the ink reservoir 108 and transferred to the nib 104, which in turn transfers the colored “water” to the plurality of flower petals 114 of each color-transfer paper disk 102. As can be deduced, in order to transport the colored “water,” the ink reservoir 108, the nib 104, and the plurality of color-transfer paper disks are comprised of porous absorbent materials. For example, the ink reservoir 108 may be constructed similar to a marker ink reservoir and the nib 104 may be constructed similar to a marker nib, through which ink is delivered when using a marker for writing, drawing, marking, and the like.

While disks 102 are described as color transfer paper disks, it should be understood that any wicking substrate having sufficient porosity and/or absorption to permit a color-transfer liquid to move through the substrate via capillary action is considered suitable. The wicking substrate may be filter paper, such as analytical filter paper having a porosity ranging from 2 to 25 microns, in some embodiments ranging from 6 to 12 microns, in some embodiments ranging from 8 to 10 microns. The wicking substrate may be made from conventional filter paper disks that are commercially available for various chemical experiments or processes, including analytical filter paper disks.

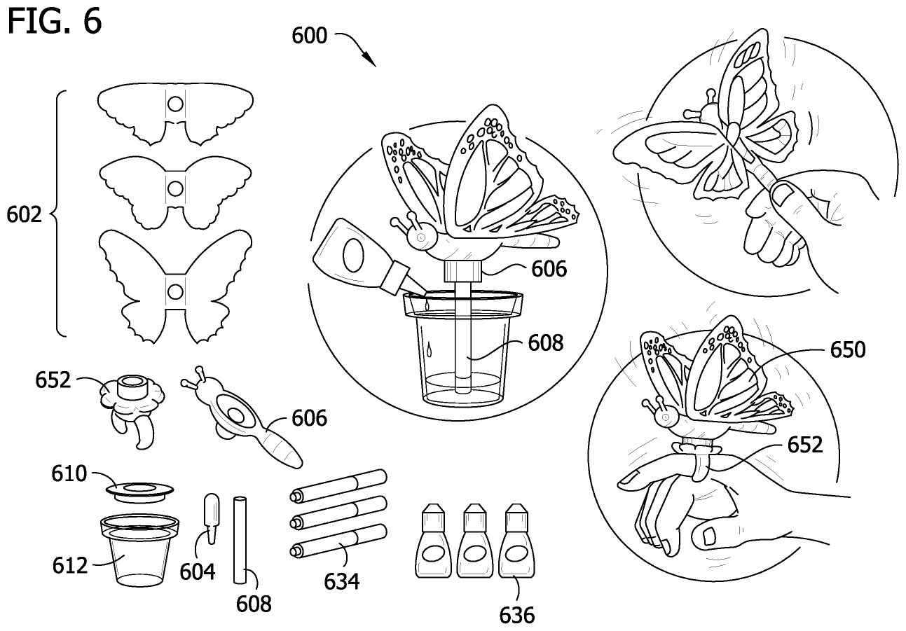

It should also be understood that the term “disk” is not limited or restricted to a round object, but includes any flat or sheet-like object having a central axis wherein portions of the disk extend outwardly from the central axis to an outer perimeter. The term “disk” encompasses any number of different shapes having a center axis such as the sheet-like object having petals extending outwardly from the central axis to an outer perimeter designated as 102 in FIG. 1, and the sheet like object having butterfly wings extending outwardly from the central axis to an outer perimeter designated as 602 in FIG. 6.

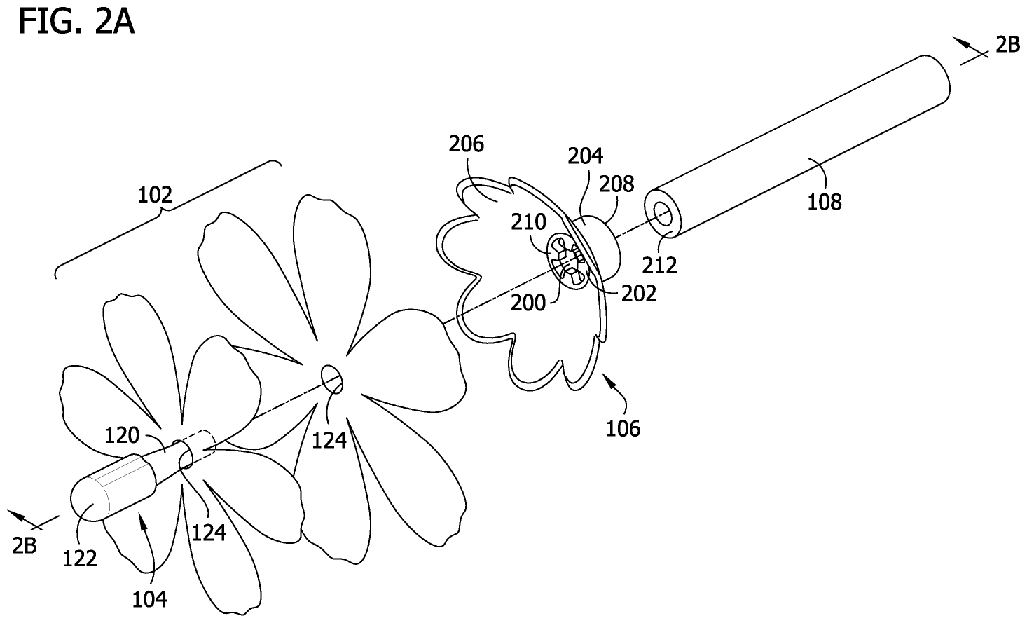

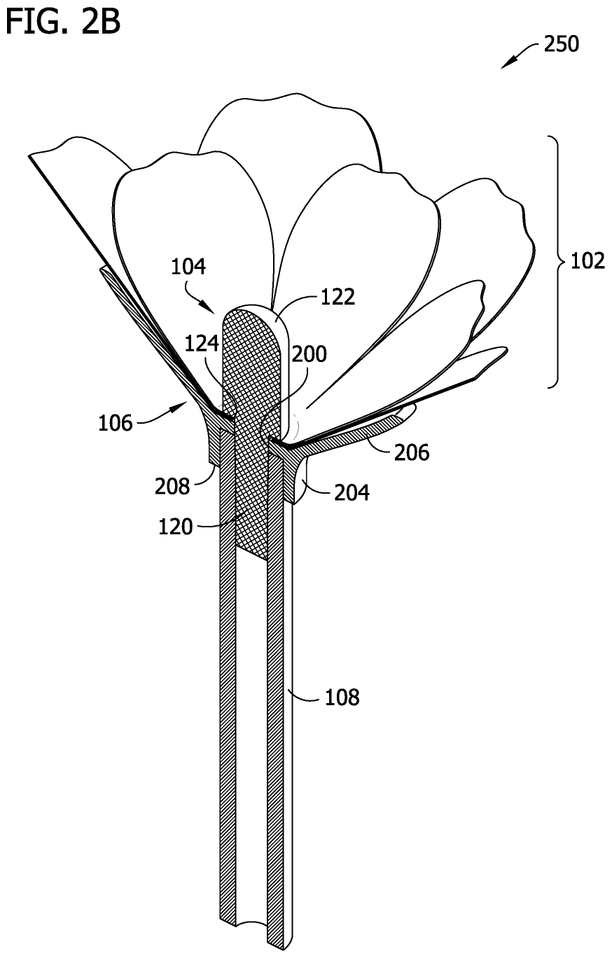

As shown in FIG. 2A, the flower portion of the flower building kit in accordance with aspects herein may be assembled by inserting a tail end 120 of the nib 104 through the central opening 124 of each color-transfer paper disk 102. Any number of color-transfer paper disks 102 may be used that would reasonably fit in the assembly, for example four, as shown in FIG. 1, or two, as shown in FIG. 2A, or even one. Then, the tail end 120 of the nib 104 may be further inserted through an opening 200 of a nib connector portion 202 located at the stem portion 204 of the support funnel 106. The nib connector portion 202 may be built into the support funnel 106, or may be provided as a separate part. The nib connector portion 202 is configured to retain the nib 104 in an upright orientation that is on the same axis as the stem portion 204 of the support funnel 106, and securely hold the color-transfer paper disks 102 in place by sandwiching them between the tip end 122 of the nib 104 and the sepal portion 206 of the support funnel 106. The stem portion 204 of the support funnel 106 is further configured to support the ink reservoir 108 in an orientation that is also on the same axis with the stem portion 204, as shown. In other words, the ink reservoir 108 is inserted through a bottom end 208 of the stem portion 204, and the tail end 120 of the nib 104 is inserted through a top end 210 of the stem portion 204 such that the tail end 120 of the nib 104 and the inserted portion 212 of the ink reservoir 108 come in contact with each other at the stem portion 204 of the support funnel 106. Once the flower is assembled, the flower 250 as shown in FIG. 2B, may be placed in a pot 112 and may be optionally supported by a cover plate 110 by inserting the ink reservoir 108 through a support opening 111 of the cover plate 110 such that the flower 250 stands in an upright position. In some aspects, in order to add a decorative aspect, the cover plate 110 may be colored and textured to resemble potting soil, pebbles, beads, and the like. Further, for easy “feeding” of the flower 250, the cover plate 110 may further comprise a notch 113 along its outer perimeter such that when assembled with the pot 112, the notch 113 may create an opening through which coloring solution may be “fed” to the flower 250.

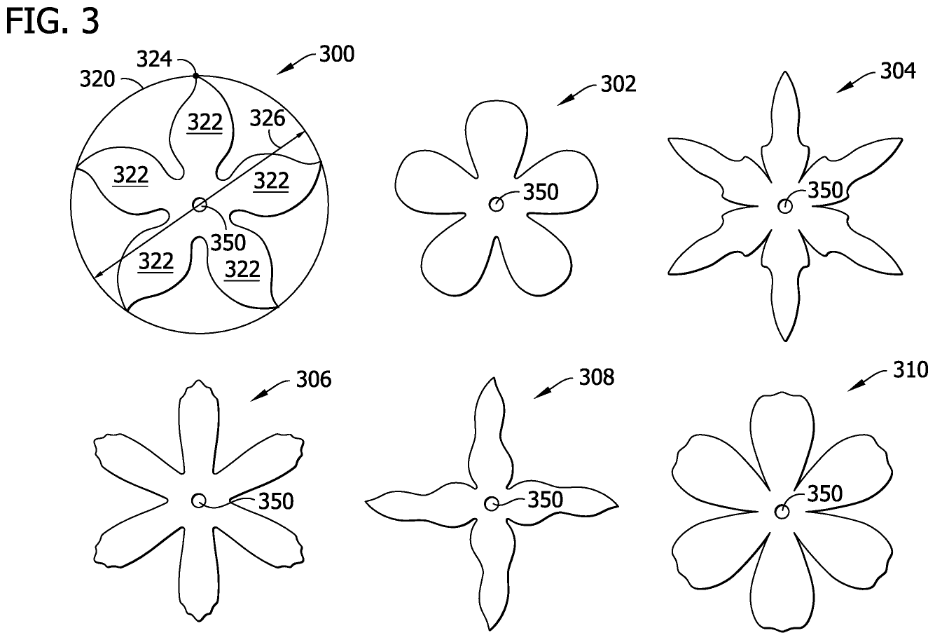

As shown in FIG. 1, the plurality of color-transfer paper disks 102 may be provided in different sizes (e.g., petal forming color-transfer paper disk 116 has a larger diameter than petal forming color-transfer paper disk 118, where the diameter of each petal forming color-transfer paper disk may be measured, as shown in FIG. 3 with reference to petal forming paper disk 300, by drawing a circle 320 around the petals 322 starting from one of the petal's furthest edge points 324 such that all petals 322 are enclosed within the circle 320, and measuring the diameter 326 of the circle 320), and/or as shown in FIG. 3, the plurality of color-transfer paper disks 102 may be provided in different shapes. For example, petal forming paper disk 300 is shaped like a star with five petals that are shaped like flames, petal forming color-transfer paper disk 302 on the other hand comprises five petals that are more symmetrical and rounded such that they are shaped more like drops. Moving on, petal forming color-transfer paper disk 304 has a greater number of petals (six) and has an overall snowflake shape, while petal forming color-transfer paper disk 308 has a smaller number of petals (four) that have an organic shape. Petal forming color-transfer paper disk 306 and petal forming color-transfer paper disk 310 are yet other exemplary six petal flower petal forming color-transfer paper disks having yet other unique petal shapes. Each color-transfer paper disk 102 (e.g., 300, 302, 304, 306, 308, 310), as shown in FIG. 3, comprises a central opening 124/350, which is configured to fit a tail end 120 of the nib 104, as described above, with reference to FIGS. 2A and 2B. As shown in FIG. 1, the tail end 120 of the nib 104 is slimmer than the tip end 122 of the nib 104. In accordance with aspects herein, the central opening 124/350 of each petal forming paper disk in the plurality of color-transfer paper disks 102 has a diameter that is equal to or greater than a diameter of the tail end 120 of the nib 104, but that is smaller than a diameter of the tip end 122 of the nib 104. The particular configuration of the nib 104 allows the tail end 120 to pass through the central opening(s) 124/350, but not the tip end 122, thus, the tip end 122 serves to lock the plurality of color-transfer paper disks 102 in place, when the paper flower(s) in accordance with aspects herein, is (are) in an assembled state. It is to be understood that FIG. 3 only depicts a few exemplary flower petal shapes and that many more may be provided without departing from aspects in accordance herein.

As briefly described above, the color-transfer paper disks 102 may be provided in different sizes. For example, the color-transfer paper disks 102 may comprise diameters ranging from, for example, 2 cm to 15 cm, including any size falling in between this range. For instance, some color-transfer paper disks 102 may have diameters of 13 cm, others may have diameters of 11.5 cm, 7.5 cm, 2.7 cm, and the like, depending on the type of flower petal design and type of flower being formed. In accordance with other aspects, blank paper disks may also be provided so that the user may be able to create their own petal forming paper disks with a personal paper design. In accordance with other aspects herein, paper punches having specific flower petal shapes may also be provided for cutting blank paper disks into color-transfer paper disks 102.

Moving back to FIG. 1, the flower building kit may optionally be further provided with a volume measuring device 130, a color mixing chart 132, a set of markers 134 comprising one or more markers, a set of ink bottles 136 comprising one or more ink bottles, a watering can 138, and a paint brush 140. For example, once the flower itself is assembled (as shown in FIGS. 4A-4C), the user may use the volume measuring device 130 to add a certain volume of water and/or a certain volume of ink from the set of ink bottles 136 (which may be a mixture of different colored inks) according to, for example, a desired level of color intensity, or according to recommended amounts described in the color mixing chart 132.

As shown in FIG. 4A, the coloring solution 402 may then be poured into the watering can 138 and be “fed” to the flower 400 through an opening 408 formed in the cover plate 110. As the coloring solution 402 becomes absorbed by the ink reservoir 108 and into the nib 104, the coloring solution 402 travels to the petals 404 of the flower 400 by capillary action, to progressively form a growing colored patch 406. As shown in FIG. 4B, as time passes, an amount of coloring solution 402 transported from the pot 112 to the petals 404 increases, thereby increasing a surface area of the colored patch 406, until the surface area of the colored patch 406 completely covers the petals 404, as shown in FIG. 4C. As also shown in FIG. 4B, a user may choose to add designs 410 to the petals 404 themselves using one or more markers in the set of markers 134, for example. As shown in FIG. 4C, the designs 410 may travel through the petals 404 with the coloring solution 402, and does move from a first location to a second location along the petals 404.

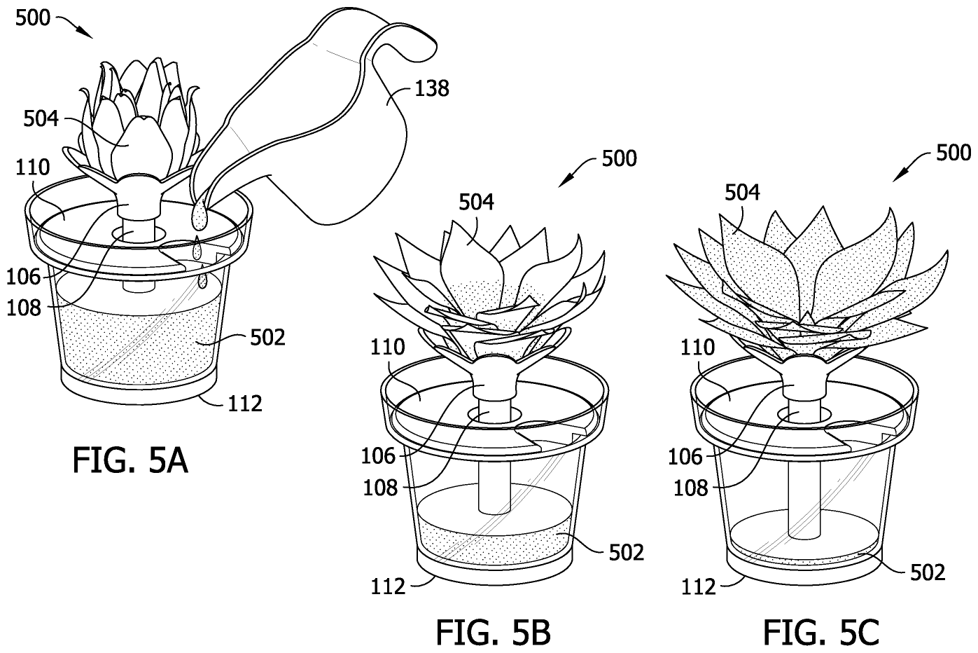

Further, as shown in FIGS. 5A-5C, two or more color-transfer paper disks 102 may be stacked and curled, such as curling a ribbon by using an edged tool and pulling each petal against the edge of the edged tool, or such as curling hair by wrapping each petal around, for example, a pencil, a marker, and the like. The curled color-transfer paper disks 102 may then be assembled (as shown in FIG. 2A) to form a flower bulb (i.e., a flower with its petals closed, or in other words, a flower that has not bloomed yet), such as the flower bulb 500 shown in FIG. 5A. Following the same steps as described above with reference to FIGS. 4A-4C, as the flower bulb 500 is “fed” the coloring solution 502, and as the flower bulb petals 504 gradually become saturated with the coloring solution 502, the flower bulb 500 may slowly start to bloom, as shown in FIG. 5B, and fully bloom when fully saturated, as shown in FIG. 5C.

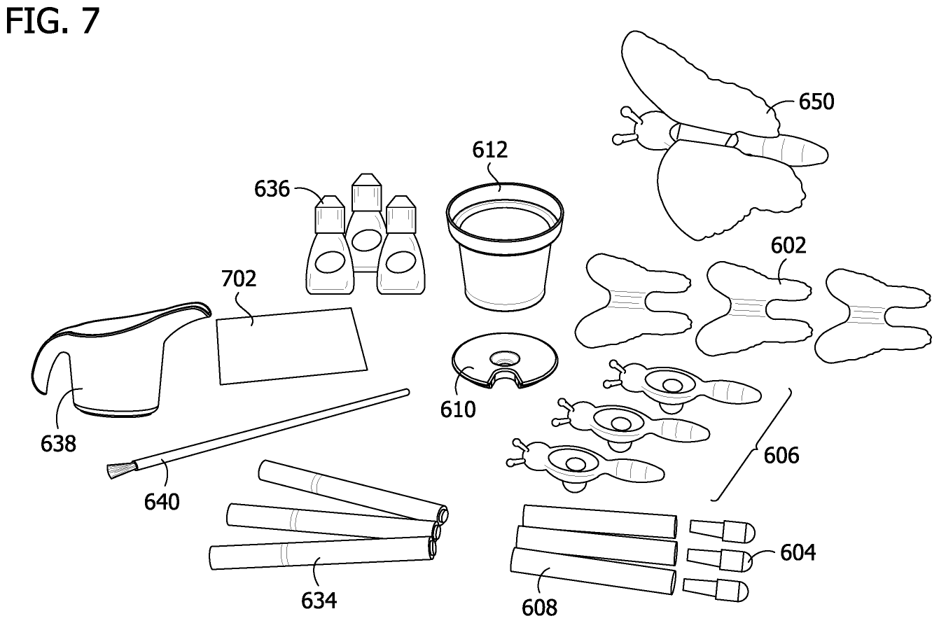

As shown in the exemplary butterfly color-transfer wicking art kits of FIGS. 6-7, a further example of a die-cut paper substrate 602 is exposed to a color-transfer liquid, such as an ink solution, based on wicking action through the color-transfer wicking art kit to transfer color onto the die-cut paper substrate. In the embodiment shown, a plurality of die-cut paper substrates 602 are provided in the kit, each of which is in the shape of a butterfly with a central axis and wings extending outwardly from opposing sides of the central axis to an outer perimeter. While each substrate is in the shape of a butterfly, the overall configuration and shape of the substrates is different such that three different shapes/sizes of butterfly substrates is provided.

The butterfly building color-transfer wicking kit 600 is similar to that of the flower building color-transfer wicking kit 100 in that it includes color-transfer paper disks 602 shaped to form butterfly wings (as opposed to flower petals). Nib 604, ink reservoir 608, cover plate 610, and pot 612 are the same components as discussed above in relation to the flower building color-transfer wicking kit. Support coupler 606 is similar to that of support funnel 106 in that it provides a well-shaped substrate support surface and a channel for positioning the nib 604 and reservoir 608 in contact for fluid flow communication. Rather than being in the shape of a flower sepal however, support coupler 60 is instead shaped like the main body of a butterfly. Kit 600 additionally includes at least one decorative ring 652 having a ring portion configured to be worn on a user's finger and a connector extending upwardly from the ring portion configured to releasably affix the support coupling 606 to the top of the ring. The kit also may include markers 634, ink bottles 636, a paint brush 640, and a water pitcher 638. One or more color-transfer wicking substrates 702 in sheet form can also be provided for a user to cut into any desired shape.

It should be understood that the paper substrates provided in the kit may be of different sizes and shapes and may be shaped to form an object alone or when affixed with other substrates in a stacked configuration. The die-cut paper substrate may be shaped to form any object in assembled form, such as a flower, butterfly, dragonfly, star, heart, or abstract shape. The die-cut substrate can be formed from any planar substrate having wicking characteristics configured to transfer a fluid containing a colorant.

In further aspects, each kit may include a reservoir transfer mechanism for transferring the color-transfer liquid, such as an ink in water, through the reservoir and into contact with the die-cut paper substrate, such as the transfer of colored ink up through the reservoir and into the substrate. Colored ink may then travel, from an inner, first point of contact where the die-cut paper substrate first touches the wicking reservoir, to an outer, second point of travel where the die-cut paper substrate is not in direct contact with the wicking reservoir.

In other aspects, a single point of contact between the wicking reservoir and the die-cut paper substrate may facilitate transfer of a colored component exposed to a first portion of the wicking reservoir, that is then transferred through the wicking reservoir and contacted with the single point of contact with the die-cut paper substrate. In other aspects, a first color derived from a first compartment housing a first colorant may be transferred to a first contact point on the die-cut paper substrate, while at the same time, a second color derived from a second compartment housing a second colorant may be transferred to a second contact point on the die-cut paper substrate. As such, a first and second ink-holding chamber may transfer, via separate reservoir wicking devices, a colored liquid from the first and second in-holding chambers, through the separate reservoir wicking devices, and through to the same die-cut paper substrate, to facilitate travel of two different ink colors through to the color-transfer wicking art shape.

In yet another aspect, an adapter may be provided to couple together a wicking reservoir to a die-cut paper substrate such that the wicking reservoir may transfer ink solution from a container, through the reservoir, and through to the die-cut paper substrate, where the colored ink solution may transfer at a rate of diffusion of the ink with respect to the die-cut paper substrate. In some aspects, the adapter may be a portion of a flower pot connecting a wicking reservoir to a flower bud die-cut substrate. In another aspect, the adapter may be an insect body, such as the butterfly body connecting the wicking reservoir to the die-cut paper butterfly, or other shaped, color-transfer wicking art.

Although aspects herein are being described in the context of having one flower per pot, it is contemplated that multiple flower holding mechanisms may also be provided, without departing from aspects in accordance with aspects herein. For example, in some aspects, larger pots with larger cover plates having multiple support openings may be provided. In other aspects, larger pots with individual ink compartments for making multiple flowers of different colors may also be provided. In yet other embodiments, multi-stem support funnels, or multi-sepal support funnels may be provided to form, for example, flower bunches.

Additionally, it is also contemplated that if petals of different flowers being colored in different ways are allowed to touch during the coloring process, “cross-pollination” or inter-coloring may also be observed, where at least the touching portions of the flower petals from the two or more touching flowers may adopt the colors from both of the two or more flowers, thereby creating different visual interest.

One exemplary embodiment of a color-transfer wicking art kit includes: a plurality of color-transfer paper disks, a nib, a petal support portion, an ink reservoir, a cover plate, and a pot. In this embodiment, the color-transfer wicking art kit may additionally one or more ink bottles, a color mixing chart, one or more markers, and/or a watering can. In addition, the plurality of color-transfer paper disks may be different sizes and/or shapes.

Another exemplary embodiment of a color-transfer wicking art kit includes: a first color-transfer paper disk having a first size, a second color-transfer paper disk having a second size different from the first size, a nib, a nib connector, an ink reservoir, a cover plate, and a pot. In this embodiment, the first color-transfer paper disk and the second color-transfer paper disk may be formed of an absorbent material. In this embodiment, the nib and the ink reservoir may be formed from marker parts. The first color-transfer paper disk and the second color-transfer paper disk may include a central hole. The nib may have a back portion and a front portion, wherein the back portion is narrower than the front portion. The back portion of the nib may be configured to fit through the central hole of each of the first color-transfer paper disk and the second color-transfer paper disk. The nib connector may be configured to hold the first color-transfer paper disk and the second color-transfer paper disk in a stacked configuration on a first surface of the nib connector when the back portion of the nib is fitted through the central hole of the first color-transfer paper disk and the second color-transfer paper disk, and through an opening of the nib connector. The opening of the nib connector may additionally be configured to receive the ink reservoir from a second surface of the nib connector such that the ink reservoir engages with the back portion of the nib.

The ink reservoir may further be configured to fit through an opening of the cover plate. The cover plate may be configured to fit within a widest portion of a pot opening of the pot. The cover plate may include a side notch on a perimeter of the cover plate to provide access to the interior of the pot. In this embodiment, the flower building kit may additionally include one or more ink bottles, wherein ink from the one or more ink bottles may be fed through the side notch of the cover plate when a wicking flower built with the flower building kit is in an assembled configuration. The kit may additionally include a petal support portion.

Another exemplary embodiment of a color-transfer wicking art kit includes: one or more die-cut paper substrates having an inner portion and an outer border; at least one wicking reservoir having a first end and a second end, wherein the at least one wicking reservoir is configured to transfer an ink solution from the first end in a position remote from the one or more die-cut paper substrates to the second end in a position directly adjacent the one or more die-cut paper substrates; and an adapter configured to couple the one or more die-cut paper substrates and the at least one wicking reservoir, such that the one or more die-cut paper substrates are positioned at a first height above the ink solution, wherein the ink solution is positioned within a holding component at a second height below the die-cut paper substrate.

From the foregoing, it will be seen that this disclosure is one well adapted to attain all the ends and objects described and with other advantages that are obvious and/or are inherent to the structure.

It will be understood that certain features and subcombinations are of utility and may be employed without reference to other features and subcombinations. This is contemplated by and is within the scope of the claims.

Since many possible embodiments may be made of the disclosure without departing from the scope, it is to be understood that all matter described or shown in the accompanying drawings is to be interpreted as illustrative and not in a limiting sense.

What is claimed is:

1. A color-transfer wicking art kit for making a colored object from a wicking substrate, the kit comprising:
a nib comprising a porous medium through which a liquid may move via capillary action, the nib having a head in fluid flow communication with a tail, wherein at least a portion of the head is larger in diameter than any portion of the tail;
an elongated reservoir comprising a porous medium through which a liquid may move, the reservoir having a first end in fluid flow communication with a second end;
a support coupling configured to releasably connect the second end of the reservoir in fluid flow communication with the tail of the nib, the support coupling having a substrate support surface; and
wherein the nib and support coupling are configured such that when the tail of the nib is inserted through a wicking substrate and connected in fluid flow communication with the second end of the reservoir via the support coupling, the substrate is releasably affixed in a wicking position between the head of the nib and the substrate support surface in fluid flow communication with the nib.

2. The kit of claim 1, wherein the nib and support coupling are configured such that the tail of the nib may be inserted through a plurality of wicking substrates in a stacked configuration and connected in fluid flow communication with the second end of the reservoir via the support coupling, the plurality of wicking substrates being releaseably affixed in the stacked configuration between the head of the nib and the substrate support surface in fluid flow communication with the nib.

3. The kit of claim 1 further comprising at least one wicking substrate through which a liquid may move via capillary action.

4. The kit of claim 3, wherein the at least one wicking substrate is made from a round filter paper disk that has been cut into a shape.

5. The kit of claim 4, wherein the at least one wicking substrate is in the shape of a plurality of flower pedals extending outwardly from a central hub.

6. The kit of claim 3, wherein the at least one wicking substrate comprises a round filter paper disk with decorative indicia.

7. The kit of claim 3, wherein the at least one wicking substrate comprises a plurality of wicking substrates, wherein at least one substrate is a different shape or size than another substrate.

8. The kit of claim 2 further comprising a plurality of wicking substrates through which a liquid may move via capillary action, the substrates including petal-shaped portions, such that the substrates appear like flowers when in a stacked position.

9. The kit of claim 1 wherein the substrate support surface comprises a well-shaped surface having a bottom wall and a peripheral sidewall extending upwardly from the bottom wall.

10. The kit of claim 9 further comprising at least one wicking substrate through which a liquid may move via capillary action, wherein the wicking substrate has a central hub portion that corresponds with the shape and size of the well-shaped surface such that at least a portion of the central hub is in abutting engagement with the bottom wall when releasably affixed in the stacked position.

11. The kit of claim 10 wherein the at least one wicking substrate comprises a plurality of wicking substrates having portions shaped like flower petals and the substrate support surface is shaped like a flower sepal.

12. The kit of claim 1 further comprising a wicking vessel configured to hold a liquid such that the first end of the reservoir is in fluid flow communication with the liquid when the reservoir is inserted into the wicking vessel.

13. The kit of claim 12 further comprising a cover plate configured to cover an open top in the wicking vessel, the cover plate comprising a reservoir support opening configured to removeably receive the first end of the reservoir and support the reservoir in an upright position with the first end of the reservoir positioned within the vessel and the second end positioned above the vessel.

14. The kit of claim 13 wherein the cover plate further comprises a pour opening configured to allow liquid to be added to the interior of the vessel from outside the vessel through the pour opening.

15. The kit of claim 1 further comprising at least one ink bottle.

16. The kit of claim 12 further comprising a transfer vessel configured to retain liquid and to transfer the liquid to the interior of the wicking vessel.

17. The kit of claim 1 further comprising a color mixing chart.

18. The kit of claim 1 further comprising at least one writing instrument.

19. The kit of claim 1 further comprising at least one decorative ring having a ring portion configured to be worn on a user's finger and a connector extending upwardly from the ring portion configured to releasably affix the support coupling to the top of the ring.

20. A flower building art kit comprising:
a first color-transfer paper disk having a first size having a petal shaped design or shape;
a second color-transfer paper disk having a second size different from the first size having a petal shaped design or shape;
an elongated color-transfer liquid reservoir adapted to convey liquid from a bottom end to a top end via capillary action;
one or more connectors configured to retain the first color-transfer paper disk and the second color-transfer paper disk in a stacked configuration above the top end of the reservoir and in fluid flow communication with the reservoir;
a container configured to retain a color-transfer liquid; and
a cover plate configured to cover an open top of the container and having one or more openings through which the bottom end of the reservoir may extend into an interior of the container to contact color-transfer liquid contained within the container.

21. The flower building kit of claim 20, wherein the one or more connectors comprise a nib configured to extend through the first color-transfer paper disk and the second color-transfer paper disks to retain the disks in a stacked configuration.

22. The flower building kit of claim 20, wherein the first color-transfer paper disk and the second color-transfer paper disk are comprised of an absorbent material.

23. The flower building kit of claim 21, wherein the nib and reservoir are respectively the nib and reservoir components used in markers.

24. The flower building kit of claim 21, wherein each of the first color-transfer paper disk and the second color-transfer paper disk comprise a central hole.

25. The flower building kit of claim 21, wherein the nib comprises a first portion and second portion, wherein the second portion is narrower than the second portion.

26. The flower building kit of claim 25, wherein the second portion of the nib is configured to fit through the central hole of each of the first color-transfer paper disk and the second color-transfer paper disk.

27. The flower building kit of claim 26, wherein the one or more connectors comprise a nib connector configured to hold the first color-transfer paper disk and the second color-transfer paper disk in the stacked configuration on a first surface of the nib connector when the second portion of the nib is fitted through the central hole of the first color-transfer paper disk and the second color-transfer paper disk, and fitted through an opening in the first surface of the nib connector.

28. The flower building kit of claim 27, wherein the opening of the nib connector is further configured to receive the reservoir through a second surface of the nib connector and engage with the second portion of the nib.

29. The flower building kit of claim 20, wherein the cover plate further comprises a side notch on a perimeter of the cover plate that provides access to an interior of the container.

30. The flower building kit of claim 29, further comprising one or more ink bottles.

31. The flower building kit of claim 30, wherein the side notch of the cover plate and the ink bottles are configured to enable a user to feed ink from the one or more ink bottles through the side notch of the cover plate.

32. The flower building kit of claim 20, further comprising a petal support surface configured to support the first color-transfer paper disk and the second color-transfer paper disk in the stacked configuration above the top end of the reservoir such that the outer perimeter of each disk is positioned higher than an inner portion of each disk.

33. A color-transfer wicking art kit comprising:
one or more die-cut paper substrates having an inner portion and an outer perimeter;
at least one wicking reservoir having a first end and a second end, wherein the at least one wicking connector is configured to transfer a color-transfer liquid from the first end in a position remote from the one or more die-cut paper substrates to the second end in a position adjacent the one or more die-cut paper substrates; and
an adapter coupling configured to couple the one or more die-cut paper substrates and the at least one wicking reservoir, such that the one or more die-cut paper substrates are positioned at a first height above the color-transfer liquid, and wherein the color-transfer liquid is positioned within a holding component at a second height below the die-cut paper substrate.
